(19) United States
(12) Patent Application Publication
(10) Pub. No.: US 2026/0138832 A1
(43) Pub. Date: May 21, 2026

(54) LIVE SIDE GUIDE ASSEMBLY FOR A SKEW ROLLER CONVEYOR

(71) Applicant: Intelligrated Headquarters, LLC, Mason, OH (US)

(72) Inventors: Jakub BARCUCH, Valasske Klobouky (CZ); Miroslav KUBO, Zilina (SK); Pavel ROTNAGL, Brno (CZ); Jan SUCHÝ, Zlín (CZ)

(21) Appl. No.: 18/955,533

(22) Filed: Nov. 21, 2024

(51) Int. Cl. B65G 21/20; B65G 13/08

(52) U.S. Cl. CPC B65G 21/2054; B65G 13/08; B65G 2201/0285

(57) ABSTRACT

A live side guide assembly for a skew roller conveyor is disclosed. The live side guide assembly comprises a plurality of retractable rolling elements positioned along at least one side of the skew roller conveyor. Further, each of the plurality of retractable rolling elements comprise a shaft defining a shaft axis, a bearing assembly positioned around the shaft and a rolling member that is positioned around the bearing assembly. The rolling member is configured to rotate on the shaft axis, wherein each of the plurality of retractable rolling elements are configured to be positioned such that the shaft axis extends vertically and each of the plurality of retractable rolling elements are configured to move between a deployed position for guiding one or more packages and a retracted position for diverting one or more packages.

### TECHNOLOGICAL FIELD

Example embodiments of the present disclosure generally relates to a live side guide assembly, and more particularly relates to a live side guide assembly for a skew roller conveyor.

### BACKGROUND

Conventional sorter systems such as the standard sorter, are designed to handle high-throughput applications in large-scale industrial settings. These sorter systems often feature complex mechanical designs with numerous moving parts including drive mechanisms, chains, and other assemblies, which contribute to their robust functionality. Typically, the conventional sorter systems face challenges such as adapting the sorter systems to future customers. Furthermore, these conventional sorter systems occupy a large amount of space due to their moving and stationary components.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a live side guide assembly for a skew roller conveyor is disclosed. The live side guide assembly comprising a plurality of retractable rolling elements configured to be positioned along at least one side of the skew roller conveyor. Each of the plurality of retractable rolling elements comprise a shaft defining a shaft axis, a bearing assembly positioned around the shaft and a rolling member that is positioned around the bearing assembly and is configured to rotate on the shaft axis. Further, each of the plurality of retractable rolling elements are configured to be positioned such that the shaft axis extends vertically, and each of the plurality of retractable rolling elements are configured to move between a deployed position for guiding one or more packages and a retracted position for diverting one or more packages.

In some embodiments, the live side guide assembly comprises a stationary component that defines a plurality of orifices. Further, the shaft of each of the plurality of retractable rolling elements extend through a respective orifice of the plurality of orifices. Further, each of the plurality of retractable rolling elements comprise a pin coupled to the shaft and a spring encased around the shaft and secured between the stationary component and the pin, wherein the spring is configured to bias the retracting rolling element to move to the retracted position.

In some embodiments, the bearing assembly comprises a ball bearing or a needle bearing. In some embodiments, the plurality of retractable rolling elements is segmented into a plurality of zones. Further, the plurality of retractable rolling elements of each of the plurality of zones are configured to move independently between the deployed position and the retracted position based at least on a size of the one or more packages. Further, each of the plurality of retractable rolling elements are coupled with an actuator that is configured to move the plurality of retractable rolling element from the retracted position to the deployed position. Further, the actuator comprises a motorized driven roller (MDR) or a servomotor with one or more cams. Further, the actuator comprises a motorized linear actuator. Further, the actuator comprises a pneumatic linear actuator.

In some embodiments, the skew roller conveyor is configured to push the one or more packages towards the plurality of retractable rolling elements to guide the one or more packages along the skew roller conveyor or divert the one or more packages to a roller conveyor. In some embodiments, the skew roller conveyor defines a rotating speed S1 and each of the plurality of retractable rolling elements defines a moving speed S2, wherein S2 is higher than S1.

In another example embodiment, a method is disclosed. The method comprising steps of positioning a plurality of retractable rolling elements along at least one side of a skew roller conveyor; coupling a bearing assembly of each of the plurality of retractable rolling elements, around a shaft defining a shaft axis; positioning a rolling member of each of the plurality of retractable rolling elements, around the around the bearing assembly. Further, the rolling member rotates on the shaft axis; positioning each of the plurality of retractable rolling elements such that the shaft axis extends vertically; and moving the plurality of retractable rolling elements between a deployed position for guiding one or more packages and a retracted position for diverting one or more packages.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIGS. 1-2 illustrate top views of a skew roller conveyor sorter according to an example embodiment;

FIG. 3 illustrates a perspective view of the skew roller conveyor sorter according to an example embodiment;

FIG. 4 illustrates a side view of a live side guide assembly for the skew roller conveyor sorter according to an example embodiment;

FIG. 5 illustrates a perspective view of the skew roller conveyor sorter according to an example embodiment;

FIG. 6 illustrates a side view of the live side guide assembly for the skew roller conveyor sorter according to an embodiment;

FIG. 7 illustrates a perspective view of the skew roller conveyor sorter according to an example embodiment;

FIG. 8 illustrates a side view of the live side guide assembly for the skew roller conveyor sorter according to an example embodiment;

FIG. 9 illustrates a perspective view of the skew roller conveyor sorter showing a plurality of retractable rolling elements segmented into a plurality of zones according to an example embodiment;

FIG. 10 illustrates a top view of a plurality of skew roller conveyors sorter according to an example embodiment;

FIGS. 11-12 illustrate perspective views of the plurality of skew roller conveyor sorter according to an example embodiment;

FIGS. 13-14 illustrate a top view of a plurality of skew roller conveyor sorter according to an example embodiment;

FIG. 15 illustrates a front view of a retractable rolling element according to an example embodiment;

FIG. 16 illustrates a sectional view of the retractable rolling element of FIG. 15 in according to an example embodiment;

FIG. 17 illustrates a front view of a retractable rolling element according to an example embodiment;

FIG. 18 illustrates a sectional view of the retractable rolling element of FIG. 17 according to an example embodiment;

FIG. 19 illustrates a front view of a retractable rolling element according to an example embodiment;

FIG. 20 illustrates a sectional view of the retractable rolling element of FIG. 19 according to an example embodiment;

FIG. 21 illustrates a front view of a retractable rolling element according to an example embodiment;

FIG. 22 illustrates a sectional view of the retractable rolling element of FIG. 21 according to an example embodiment;

FIG. 23 illustrates a front view of a live side guide assembly having a plurality of retractable rolling elements according to an example embodiment;

FIG. 24 illustrates a top view of the live side guide assembly of FIG. 23 according to an example embodiment;

FIG. 25 illustrates a front view of a live side guide assembly having a plurality of retractable rolling elements according to an example embodiment; and

FIG. 26 illustrates a top view the live side guide assembly of FIG. 25 according to an example embodiment.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a live side guide assembly for a skew roller conveyor. The live side guide assembly includes a plurality of retractable rolling elements positioned along at least one side of the skew roller conveyor. Embodiments may be configured to rotate and extend vertically with respect to the skew roller conveyor. Embodiments may be configured to move between a deployed position for guiding one or more packages and a retracted position for diverting one or more packages.

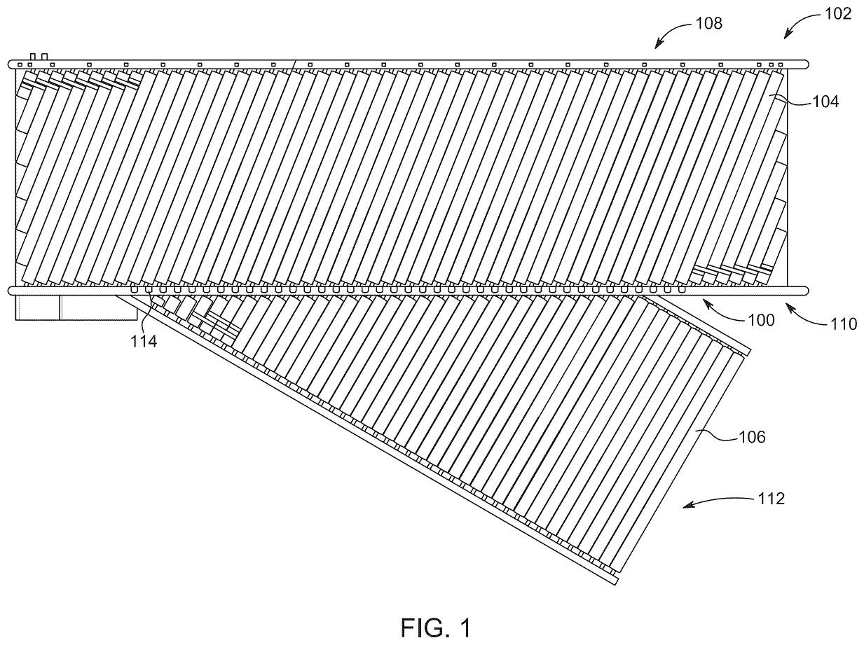

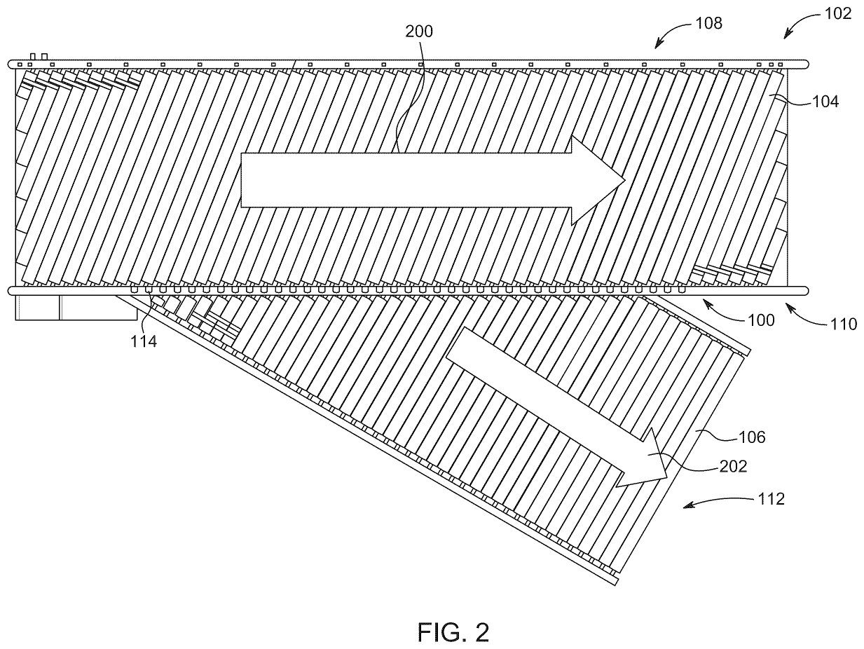

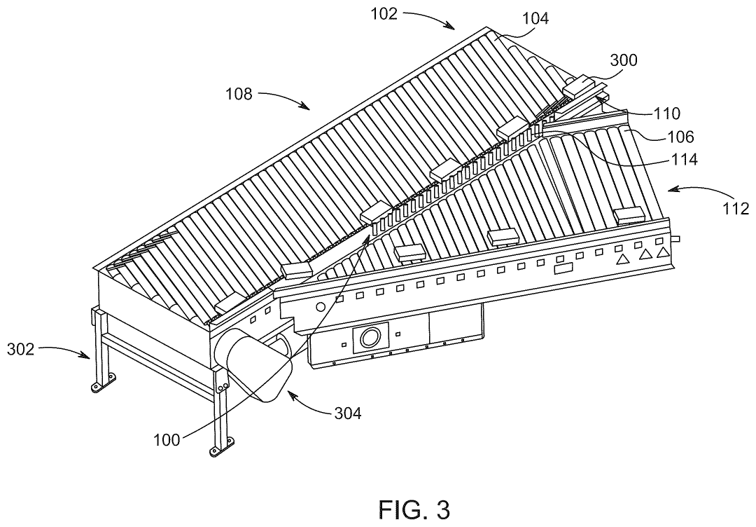

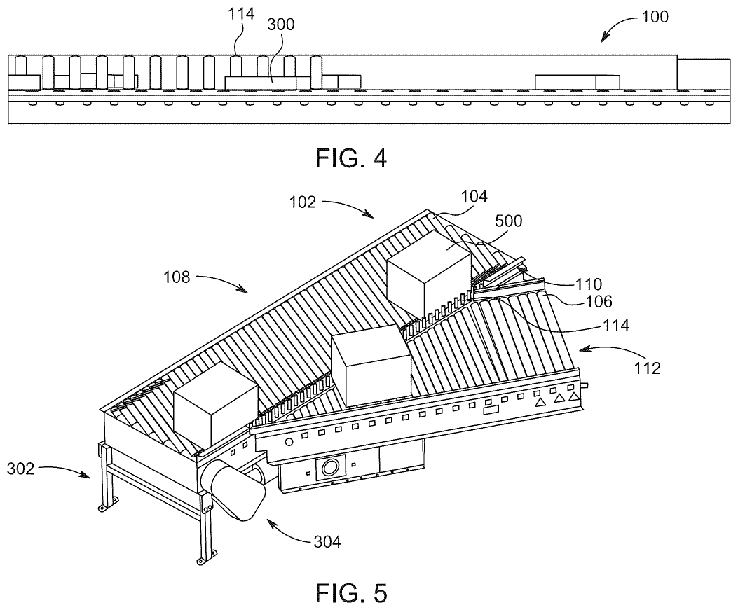

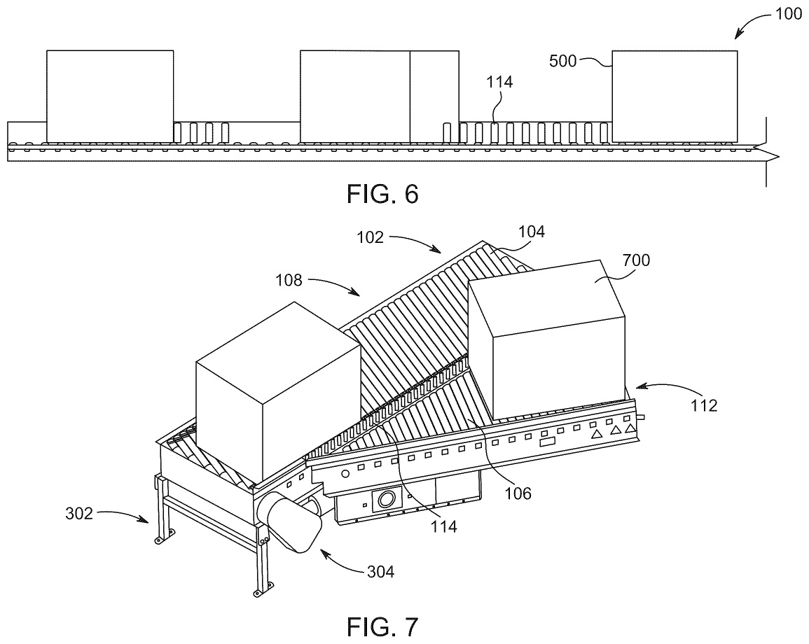

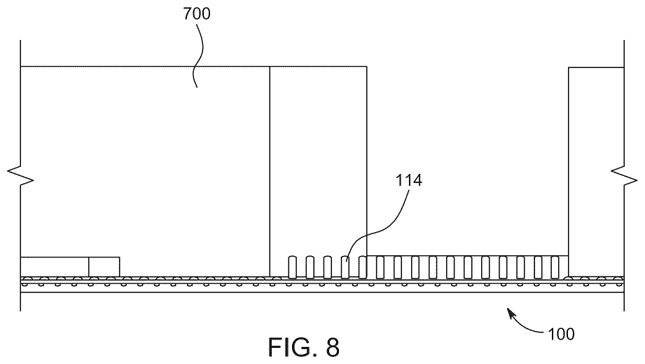

FIGS. 1-2 illustrate top views of a skew roller conveyor sorter 102, according to an example embodiment. FIG. 3 illustrates a perspective view of the skew roller conveyor sorter 102, according to an example embodiment. FIG. 4 illustrates a side view of a live side guide assembly 100 for the skew roller conveyor sorter 102, according to an example embodiment. FIG. 5 illustrates a perspective view of the skew roller conveyor sorter 102, according to an example embodiment. FIG. 6 illustrates a side view of the live side guide assembly 100 for the skew roller conveyor sorter 102, according to an embodiment. FIG. 7 illustrates a perspective view of the skew roller conveyor sorter 102, according to an example embodiment. FIG. 8 illustrates a side view of the live side guide assembly for the skew roller conveyor sorter 102, according to an example embodiment.

In some embodiments, the live side guide assembly 100 is coupled to the skew roller conveyor sorter 102, as shown in FIGS. 1-2.. In some embodiments, the skew roller conveyor sorter 102 may include a plurality rollers 104 arranged at an angle (or skewed) relative to the direction of one or more packages 300 (shown in FIG. 3). The plurality of rollers 104 arranged at an angle (or skewed) are used to control positioning of the one or more packages 300 as the one or more packages 300 may be guided, reoriented, or aligned with the edge of the skew roller conveyor sorter 102. In an example, the straight conveyor may include a plurality of rollers 106 that rotate to divert one or more packages in a straight path. In some embodiments, the live side guide assembly 100 may be positioned along at least one side of the skew roller conveyor sorter 102. In an example, the live side guide assembly 100 may be positioned along a left edge 108 or right edge 110 of the skew roller conveyor sorter 102 with respect to direction of movement of the one or more packages 300. In some embodiments, an another roller conveyor 112 i.e., a straight conveyor may be coupled to the live side guide assembly 100 of the skew roller conveyor sorter 102 such that the plurality of rollers 104 of the skew roller conveyor sorter 102 may divert the one or more packages towards the another roller conveyor 112.

In some embodiments, the live side guide assembly 100 may comprise a plurality of retractable rolling elements 114. A plurality of retractable rolling elements 114 may be configured to be positioned along at least one side of the skew roller conveyor sorter 102. In an example, the plurality of retractable rolling elements 114 may be positioned along the left edge 108 or the right edge 110 of the skew roller conveyor sorter 102. In some embodiments, the plurality of retractable rolling elements 114 may be aligned linearly along the left edge 108 or the right edge 110 of the skew roller conveyor sorter 102. In an example, as shown in FIGS. 1-2, the plurality of retractable rolling elements 114 are arranged at the right edge 110 of the skew roller conveyor sorter 102. Herein, the skew roller conveyor sorter 102 that in an instance moves the one or more packages 300 in a straight direction 200 and towards the plurality of retractable rolling elements 114. Further, the plurality of retractable rolling elements 114 is configured to divert the one or more packages 300 towards the another roller conveyor 112 that moves the one or more packages in a different direction as per requirements.

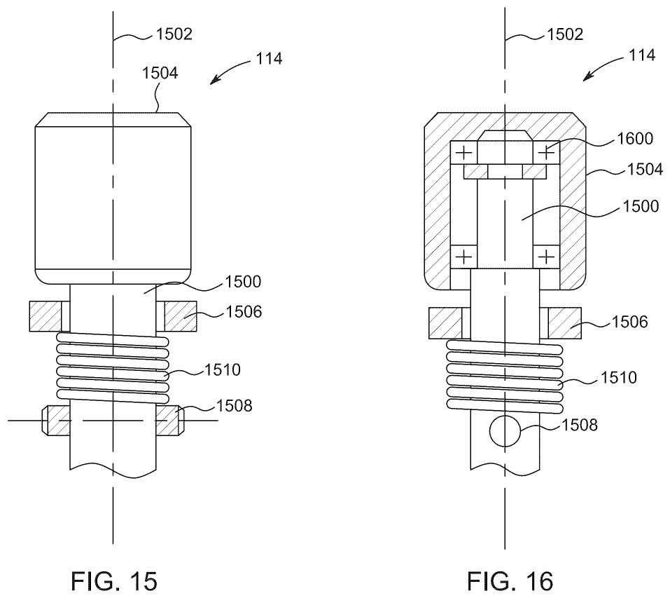

In some embodiments, each of the plurality of retractable rolling elements 114 may comprise a shaft 1500 (FIG. 15) defining a shaft axis 1502 (FIG. 15) such that a rolling member 1504 (FIG. 15) is configured to rotate on the shaft axis 1502. Further, each of the plurality of retractable rolling elements 114 may be positioned such that the shaft axis 1502 extends vertically, and each of the plurality of retractable rolling elements 114 may move between a deployed position for guiding the one or more packages 300 and a retracted position for diverting the one or more packages 300. In an example, each of the plurality of retractable rolling elements 114 may move in the deployed position for guiding some of the one or more packages 300 in the straight direction 200. Further, each of the plurality of retractable rolling elements 114 may move in the retracted position for diverting some of the one or more packages 300 towards a different direction 202. When a retractable rolling element 114 is retracted, the one or more packages 300 may be allowed to move over the retractable rolling element 114 to divert the one or more packages 300.

In an example embodiment, the live side guide assembly 100 is coupled to the skew roller conveyor sorter 102, as shown in FIG. 3. The skew roller conveyor sorter 102 may be arranged over a frame 302 having one or more control elements 304. The skew roller conveyor sorter 102 may be mounted on the frame 302 or coupled to the frame 302, which serves as supporting structure. The frame 302 may be equipped with the one or more control elements 304 that regulate the operation of the skew roller conveyor sorter 102 such as speed, direction, or sorting functions. In some embodiments, the live side guide assembly 100 may be positioned along the right edge 110 of the skew roller conveyor sorter 102. Further, the another roller conveyor 112 may be coupled to the live side guide assembly 100 of the skew roller conveyor sorter 102. In some embodiments, the skew roller conveyor sorter 102 guides the one or more packages 300 guided by the plurality of retractable rolling elements 114, to move on the straight path on the skew roller conveyor sorter 102. Further, the another roller conveyor 112 provides an alternative exit path for the one or more packages 300. Furthermore, the plurality of rollers 104 of the skew roller conveyor sorter 102 may divert the one or more packages 300 towards the alternative exit path over the another roller conveyor 112. In some embodiments, the plurality of retractable rolling elements 114 may be aligned linearly on the live side guide assembly 100 along the right edge 110 of the skew roller conveyor sorter 102.

In some embodiments, the skew roller conveyor sorter 102 may be operated manually by a user or communicatively coupled to a display unit (not shown) via at least one processor (not shown). The display unit may be remotely operated by the user to adjust speed, direction, or sorting functions of the skew roller conveyor sorter 102. In some embodiments, the at least one processor may include suitable logic, circuitry, and/or interfaces that are operable to execute one or more instructions from the display unit to perform predetermined operations. In one embodiment, the at least one processor may be configured to decode and execute any instructions received from one or more other electronic devices or server(s). The at least one processor may be configured to execute one or more computer-readable program instructions, such as program instructions to carry out any of the functions described in this description. Further, the at least one processor may be implemented using one or more processor technologies known in the art. Examples of the at least one processor 18 may include, but are not limited to, one or more general purpose processors and/or one or more special purpose processors (e.g., digital signal processors or Field Programmable Gate Array (FPGA) processor).

In some embodiments, based on information received from the user via the display unit, the at least one processor may operate the plurality of retractable rolling elements 114 of the live side guide assembly 100. In some embodiments, the plurality of retractable rolling elements 114 may move between the deployed position and the retracted position, based on requirements of the user. In an instance, when the user generates instructions over the display unit to transfer the one or more packages 300 towards the end of the skew roller conveyor sorter 102, the at least one processor may move the plurality of retractable rolling elements 114 into the deployed position. The plurality of retractable rolling elements 114 in the deployed position function as barrier between the skew roller conveyor sorter 102 and the another roller conveyor 112. Due to this barrier, the one or more packages 300 continue to move straight towards the end of the skew roller conveyor sorter 102 (as shown in FIG. 5).

In another instance, when the user generates instructions over the display unit to transfer the one or more packages 300 towards the another roller conveyor 112 i.e., take the alternative exit path, the at least one processor may move the plurality of retractable rolling elements 114 into the retracted position. The plurality of retractable rolling elements 114 in the retracted position diminishes the barrier between the skew roller conveyor sorter 102 and the another roller conveyor 112. Due to this, the one or more packages 300 while moving on the skew roller conveyor sorter 102, may be diverted towards the another roller conveyor 112, and the one or more packages 300 may follow the alternative exit path (as shown in FIG. 6).

In some embodiments, a fixed number of the plurality of retractable rolling elements 114 to be deployed or retracted may be dependent on the size of the one or more packages 300. In an example, more number of the plurality of retractable rolling elements 114 may be retracted by the at least one processor in an instance when the one or more packages 300 are of large size. In another example, less number of the plurality of retractable rolling elements 114 may be retracted by the at least one processor in an instance when the one or more packages 300 are of small size, to ensure that the one or more packages 300 may be diverted towards the alternate exit path one by one.

In an example, different sizes of the one or more packages 300 may be shown in FIGS. 3-4, FIGS. 5-6, and FIGS. 7-8. For example, small size packages of the one or more packages 300 are shown in FIGS. 3-4, medium size packages 500 of the one or more packages 300 may be shown in FIGS. 5-6 and large size packages 700 of the one or more packages 300 may be shown in FIGS. 7-8. As shown in FIG. 4, according to small size packages (of the one or more packages 300) such as small boxes or cartons, few of the plurality of retractable rolling elements 114 may be retracted to accommodate the small size packages (of the one or more packages 300) one by one. This ensures that the small size packages (of the one or more packages 300) move one by one in an orderly fashion towards the alternate exit path, preventing multiple small packages from being diverted together or creating hindrance. For instance, when handling small items like mobile phones or small electronic gadgets packed in the small size packages (of the one or more packages 300), minimal retraction of the plurality of retractable rolling elements 114 may be sufficient to direct the small size packages (of the one or more packages 300) towards the alternate exit path of the another roller conveyor 112.

In another example, in FIGS. 5-6, the medium size packages 500 (shown in FIG. 5), such as cartons or boxes of moderate size, may require less number of the plurality of retractable rolling elements 114 to be retracted compared to the large packages 700 (shown in FIG. 7). For example, if the medium size packages 500 comprise a box of electronics or home goods, only a moderate number of the plurality of retractable rolling elements 114 may be retracted via the at least one processor to create a suitable passage for the medium size packages 500, one by one in an orderly fashion. Further, in another example, FIGS. 7-8, in the case of the large size packages 700, such as bulky boxes or large crates, a significant number of the plurality of retractable rolling elements 114 may be retracted to create a wider space for the large size packages 700. This ensures that the large size package 700 may be smoothly diverted to the alternate exit path of the another roller conveyer 112 without causing congestion. For instance, when moving large appliances or furniture items packed in the large size packages 700, more number of the plurality of retractable rolling elements 114 may be retracted to accommodate their size. In various examples, the skew roller conveyor sorter 102 may be installed with various sensors (not shown) (e.g., ultrasonic sensors, infrared (IR) sensors, optical sensors etc.) to determine size of the one or more packages 300.

FIG. 9 illustrates a perspective view of the skew roller conveyor sorter 102 showing a plurality of retractable rolling elements 114 segmented into a plurality of zones 900, according to an example embodiment.

In some embodiments, the plurality of retractable rolling elements 114 may be segmented into the plurality of zones 900. Further, the plurality of retractable rolling elements 114 of each of the plurality of zones 900 may be configured to move independently between the deployed position and the retracted position based at least on a size of the one or more packages 300. In an example, the plurality of zones 900 may be referred as plurality of live side guide zones as the at least one processor may control the plurality of retractable rolling elements 114 in near real time. The at least one processor may control the plurality of retractable rolling elements 114 based on requirements, to move the one or more packages from upstream to downstream of the skew roller conveyor sorter 102 or the another roller conveyor 112 (in case of alternate exit path). Further, the plurality of retractable rolling elements 114 of each of the plurality of zones 900 or live side guide zones may be configured to move between the deployed position and the retracted position (as shown by arrows 902) based at least on a size of the one or more packages 300.

In an example, the one or more packages 300 may be small, medium or large size packages as shown in FIGS. 3-8, moving over the plurality of rollers 104 of the skew roller conveyor sorter 102. The number of plurality of retractable rolling elements 114 of each of the plurality of zones 900 may be retracted via the at least one processor based on size of the one or more packages 300. In an example, the user may provide an input on the display unit regarding the one or more packages to be a large package. Upon receiving the input, the at least one processor may generate instructions to retract plurality of retractable rolling elements 114 corresponding to at least two or more zones of the plurality of zones 900, such that space of the at least two or more zones of the plurality of zones 900 is sufficient enough for the large size package to pass. As shown in FIG. 9, the live side guide assembly 100 may be segregated into at least three zones of the plurality of zones 900. Based on the size of the one or more packages 300, the plurality of retractable rolling elements 114 of the one or more of the at least three zones may be retracted to provide space for the one or more packages 300 to be diverted towards the another roller conveyor 112.

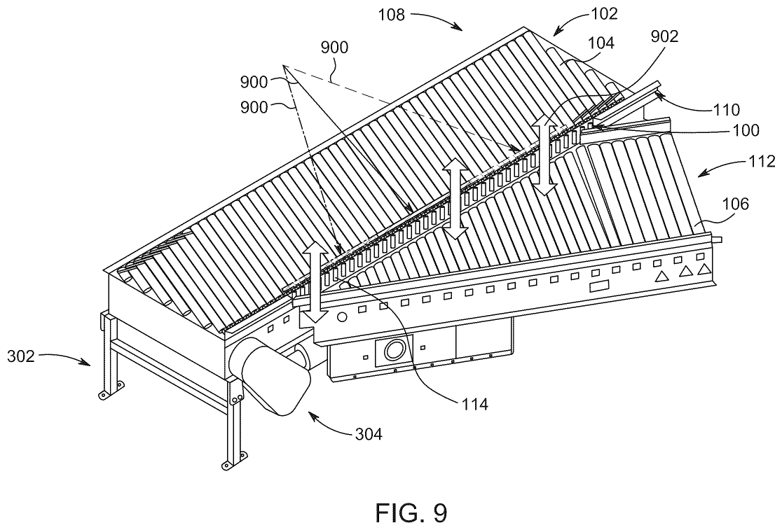

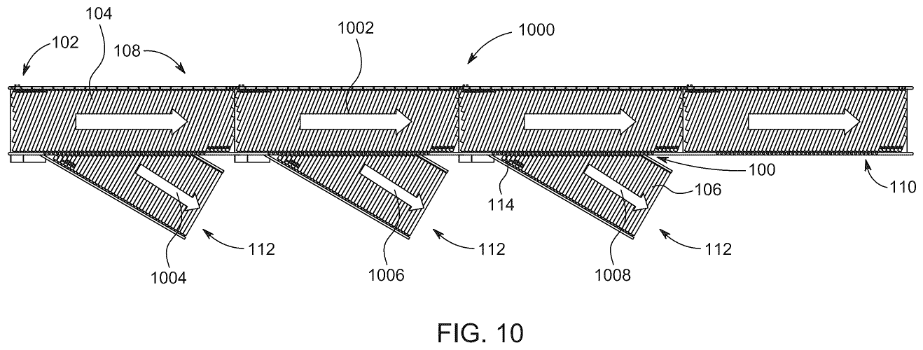

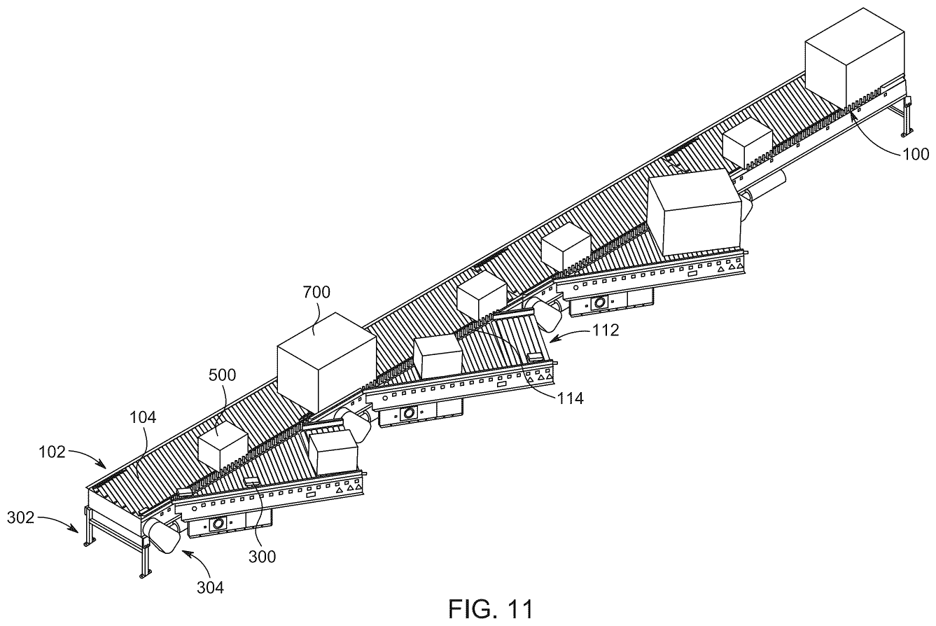

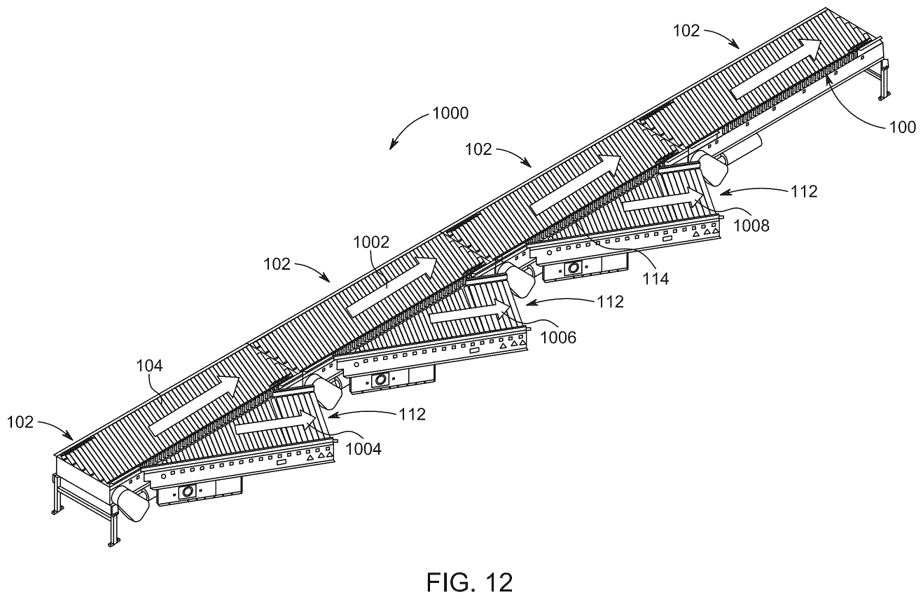

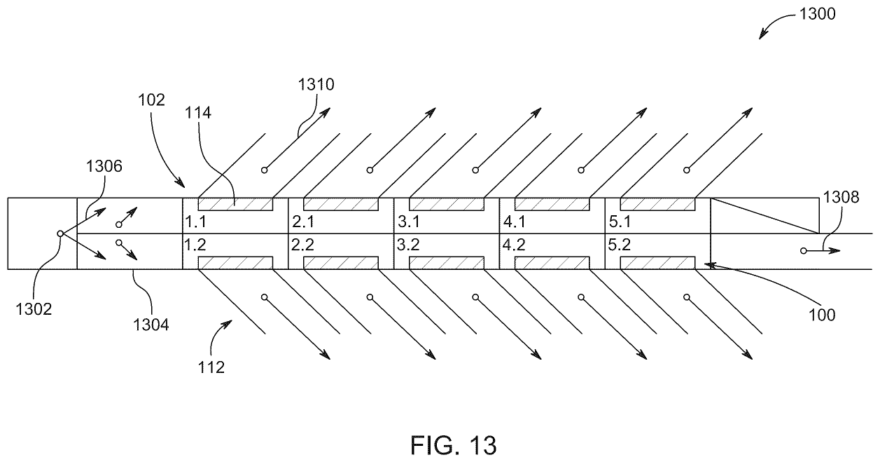

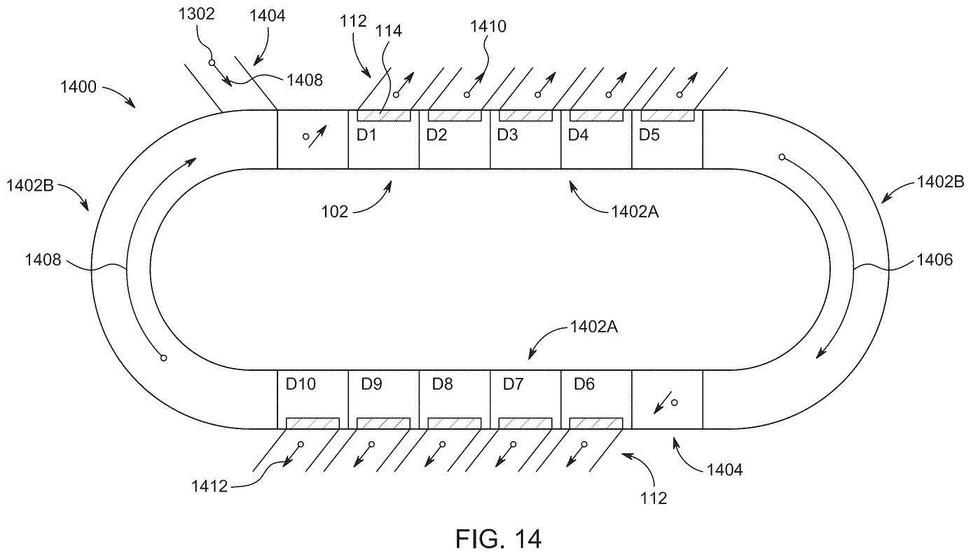

FIG. 10 illustrates a top view of a plurality of skew roller conveyors 1000, according to an example embodiment. FIGS. 11-12 illustrate perspective views of the plurality of skew roller conveyors 102, according to an example embodiment. FIGS. 13-14 illustrate a top view of the plurality of skew roller conveyors 1000, according to an example embodiment.

According to an example embodiment, the plurality of live side guide assemblies 100 are positioned along the plurality of skew roller conveyors 1000, as shown in FIG. 10-12. In an example, the plurality of skew roller conveyors 1000 are configured to push the one or more packages 300 towards the plurality of retractable rolling elements 114 to guide the one or more packages 300 along each skew roller conveyor sorter 102 of the plurality of skew roller conveyors 1000 or divert the one or more packages 300 to the another roller conveyor 112. Further, each of the skew roller conveyor sorter 102 defines a rotating speed S1 and each of the plurality of retractable rolling elements 114 defines a moving speed S2, wherein S2 is higher than S1. Further, the live side guide assembly 100 may be positioned along at least one side of each of the plurality of skew roller conveyors 1000. In an example, the live side guide assembly 100 may be positioned along the right edge 110 of each of the plurality of skew roller conveyors 1000. Further, each of the live side guide assemblies 100 may be coupled to the another roller conveyor 112, such that other roller conveyors (not shown) similar to the another roller conveyor 112 represent alternate exit paths as a first diversion 1004, a second diversion 1006, and a third diversion 1008. In an example, the other roller conveyors representing the alternate exit paths as the first diversion 1004, the second diversion 1006, and the third diversion 1008 may define the rotating speed of respective rollers greater than the rotating speed S1.

In an example, the plurality of live side guide assemblies 100 positioned along each of the skew roller conveyor sorter 102 of the plurality of skew roller conveyors 1000, may be installed in a factory setting. The factory setting may be a manufacturing facility requiring transport of one or more raw material from one section of the manufacturing process to another. Each of such sections may be arranged downstream to each of the other roller conveyors similar to the another roller conveyor 112. In order to segregate the one or more raw material as per the different sections, the one or more raw material need to be diverted along at least the first diversion 1004, the second diversion 1006 or the third diversion 1008. In an example, a first raw material may be transported to a first section of the manufacturing facility. The first raw material may be placed at one end of the plurality of skew roller conveyors 1000. Further, the at least one processor may actuate the plurality of rollers 104 to move the first raw material in a downstream direction 1002 of the plurality of skew roller conveyors 1000. Further, to transport the first raw material towards the first section, the at least one processor may generate instructions to retract the plurality of retractable rolling elements 114 of one of the plurality of skew roller conveyors 1000 to divert the first raw material towards the first diversion 1004.

Further, a second raw material may be transported to a second section of the manufacturing facility. The second raw material may be placed at one end of the plurality of skew roller conveyors 1000. Further, the at least one processor may actuate the plurality of rollers 104 to move the second raw material in the downstream direction 1002 of the plurality of skew roller conveyors 1000. Further, to transport the second raw material towards the first section, the at least one processor may generate instructions to deploy the plurality of retractable rolling elements 114 of one of the plurality of skew roller conveyors 1000 and retract the plurality of retractable rolling elements 114 of another of the plurality of skew roller conveyors 1000 corresponding to the second section. The plurality of retractable rolling elements 114 of one of the plurality of skew roller conveyors 1000 guide the second raw material towards the downstream direction 1002 i.e., towards the second section. Further, the plurality of retractable rolling elements 114 of another of the plurality of skew roller conveyors 1000 corresponding to the second section provide passage to divert the second raw material towards the second diversion 406 leading to the second section of the manufacturing facility.

Similarly, for a third raw material, the at least one processor may deploy the plurality of retractable rolling elements 114 of some of the plurality of skew roller conveyors 1000 to guide the third raw material further in the downstream direction 1002 towards the third section. Further, the at least one processor may retract the plurality of retractable rolling elements 114 of other of the plurality of skew roller conveyors 1000 to divert the third raw material towards the third diversion 1008, leading to the third section of the manufacturing facility.

According to an example embodiment, plurality of live side guide assemblies 100 are positioned along each of the skew roller conveyor sorter 102 (as shown in FIG. 13). Herein, the plurality of live side guide assemblies 100 may be positioned along both sides of the skew roller conveyor sorter 102. In an example, the plurality of live side guide assemblies 100 may be positioned along both left edge 108 and right edge 110 of the skew roller conveyor sorter 102 to form a double sided roller conveyor sorter 1300. The double sided roller conveyor sorter 1300 may comprise plurality of diversions (shown as 1.1, 1.2, 2.1, 2.2 etc.) at both sides of each of the skew roller conveyor sorter 102. In an example, the one or more packages 300 entering one of the skew roller conveyor sorter 102, may be sorted left and right according to the plurality of diversions. The plurality of diversions may correspond to the other roller conveyors similar to the another roller conveyor 112, coupled to the skew roller conveyor sorter 102 by means of the plurality of live side guide assemblies 100. The second roller conveyor may be positioned along the skew roller conveyor sorter 102 at predefined gaps to ensure smooth transfer of the one or more packages 300 downstream to the one or more of the plurality of diversions (i.e., the another roller conveyor 112).

Further, in some embodiments, the one of the skew roller conveyor sorter 102, ideally the first one in the double sided roller conveyor sorter 1300, may be coupled to a platform having a plurality of wheels 1302 for pre-alignment (shown as 1306) of the one or more packages 300 towards the skew roller conveyor sorter 102 and metering of the one or more packages 300. The one or more packages 300 may be placed on the platform. The at least one processor may operate the plurality of wheels 1302 to arrange and sort the one or more packages 300 in a set of metering lanes 1304 directed towards each side of the double sided roller conveyor sorter 1300. The metering lanes may be indents on the platform for ensuring uniform gaps and space between the one or more packages 300, before movement of the one or more packages 300 on to the skew roller conveyor sorter 102.

In an example, the double sided roller conveyor sorter 1300 may comprise the skew roller conveyor sorter 102 having at least ten diversions or at least ten divert exits (D1, D2, D3, D4 etc., as shown in FIG. 14) at each side of the skew roller conveyor sorter 102. In an example, each of the skew roller conveyor sorter 102 may comprise at least two divert exits, for example, a roller conveyor 1 may comprise the diver exits as 1.1 and 1.2, another roller conveyor 2 may comprise the divert exits as 2.1 and 2.2. In an example, a predefined sorting scheme may be provided by the user or preconfigured within the at least one processor. The at least one processor may operate the plurality of wheels to arrange and sort the one or more packages 300 in the set of metering lanes. Further, the at least one processor may operate the plurality of retractable rolling elements 114 to guide and move the one or more packages 300 downstream of the skew roller conveyor sorter 102. The arrows pointing away from the skew roller conveyor sorter 102 indicate the direction in which the one or more packages 300 are diverted at each specific diver exit (shown as the direction 1310). The one or more packages 300 are sorted to various divert exits on both the left and right edges of the double sided roller conveyor sorter 1300 or some of the one or more packages may exit the plurality of roller conveyors 1300, through an exit marked as the direction 1308.

In some embodiments, plurality of live side guide assemblies 100 positioned along the plurality of skew roller conveyors 1000 may be shown in FIG. 14. In an example, the plurality of live side guide assemblies 100 may be positioned along a loop sorter roller conveyor 1400. In some embodiments, the loop sorter roller conveyor 1400 may be a one sided loop sorter roller conveyor or a double sided loop sorter roller conveyor. In some embodiments, the loop sorter roller conveyor 1400 may comprise one or more skew straight sections 1402A and one or more curved sections 1402B. In some embodiments, the one or more straight sections 1402A may comprise the at least ten diversions or at least ten divert exits (D1, D2, D3, D4 etc., as shown in FIG. 14). The one sided loop sorter roller conveyor may include one or more induction points 1404, whereas, the double sided loop sorter roller conveyor may include the one or more induction points 1404 on both sides of the loop sorter roller conveyor 1400 (inside and outside of the loop sorter roller conveyor 1400). The one sided loop sorter roller conveyor may sort the one or more packages 300 to one side i.e., outwards (as shown by the arrow 1410). The double sided loop sorter roller conveyor may sort the one or more packages 300 to both sides (as shown by the arrow 1410 and the arrow 1412).

In an example, the one or more packages 300 may be placed at the one or more induction points 1404. The one or more packages 300 may move along the loop sorter roller conveyor 1400. Further, the at least one processor may operate the plurality of retractable rolling elements 114 of the plurality of live side guide assemblies 100 to divert the one or more packages 300 towards one or more sides of the loop sorter conveyor 1400. In an example, the sorting of the one or more packages 300 may be performed at linear portions (made of the skew roller conveyor sorter 102) of the loop sorter roller conveyor 1400 and curved portions (shown as arrows 1406 and 1408) may be used to move the one or more packages 300 from one end of the loop sorter roller conveyor 1400 to another. Further, in an example, the loop sorter roller conveyor 1400 may include the plurality of wheels 1302 to arrange and sort the one or more packages 300 in the set of metering lanes 1304 at the one or more induction points 1404. Further, the at least one processor may operate the plurality of retractable rolling elements 114 to guide and move the one or more packages 300 downstream of the loop sorter roller conveyor 1400. The arrows 1410, 1412 pointing away from the loop sorter roller conveyor 1400 indicate the direction in which the one or more packages 300 are diverted at each specific divert exit. In an example, each of the diver exits may be the another roller conveyor 112. The one or more packages 300 are sorted to various divert exits on both the inwards and outward sides of the double sided loop sorter roller conveyor based at least on the positioning of the one or more induction points 1404. In an example, the one or more induction points 1404 for outer side of the loop sorter roller conveyor 1400 may be outside the curved portion, whereas, the one or more induction points 1404 for inner side of the loop sorter roller conveyor 1400 may be inside the curved portion.

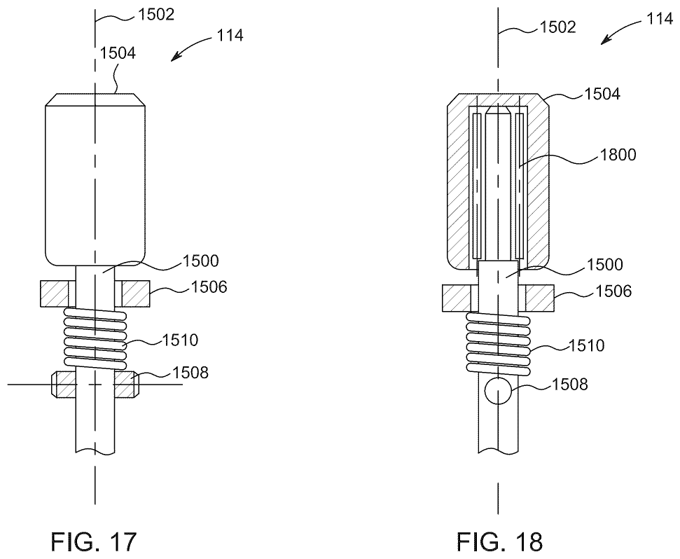

FIG. 15 illustrates a front view of a retractable rolling element 114, according to an example embodiment. FIG. 16 illustrates a sectional view of the retractable rolling element 114 of FIG. 15, according to an example embodiment. FIG. 17 illustrates a front view of a retractable rolling element 114, according to an example embodiment. FIG. 18 illustrates a sectional view of the retractable rolling element 114 of FIG. 17, according to an example embodiment.

In some embodiments, each of the plurality of retractable rolling elements 114 comprise the shaft 1500. Further, the shaft 1500 of each of the plurality of retractable rolling elements 114 may be constructed with various shapes. Further, the shapes may include but are not limited to a cylindrical shape, cuboidal shape, etc. In some embodiments, the plurality of retractable rolling elements 114 may be configured to be positioned along at least one side of the skew roller conveyor sorter 102. In some embodiments, the live side guide assembly 100 of the skew roller conveyor sorter 102 may comprise a stationary component 1506. In some embodiments, the stationary component 1506 of the live side guide assembly 100 of the skew roller conveyor sorter 102 may be configured to allow coupling of the plurality of retractable rolling elements 114 with the live side guide assembly 100 of the skew roller conveyor sorter 102. In some embodiments, the stationary component 1506 of the live side guide assembly 100 may be constructed with a planar surface. Further, the stationary component 1506 may be integrated with the at least one side of the skew roller conveyor sorter 102. For example, the stationary component 1506 may be a rail of the skew roller conveyor sorter 102

In some embodiments, the stationary component 1506 may define a plurality of orifices. In some embodiments, the plurality of orifices of the stationary component 1506 may be configured enable coupling of the plurality of retractable rolling elements 114 with the stationary component 1506. In some embodiments, the plurality of orifices may be constructed through various processes. The process may include but are not limited to drilling, cutting, molding, casting etc. Further, each of the plurality of retractable rolling elements 114 may be positioned on the live side guide assembly 100 through a respective orifice of the plurality of orifices. In some embodiments, the plurality of orifices may be configured to receive a shaft 1500 of a retractable rolling element 114. In some embodiments, each of the plurality of orifices may define a diameter similar to a diameter of the shaft 1500 of a retractable rolling element 114. In some embodiments, the shaft 1500 of each of the plurality of retractable rolling elements 114 may be configured to extend through a respective orifice of the plurality of orifices.

In some embodiments, each of the plurality of retractable rolling elements 114 may comprise a bearing assembly 1600 (as shown in FIG. 16). In some embodiments, the bearing assembly 1600 of each of the plurality of retractable rolling elements 114 may be positioned around the shaft 1500 of the respective retractable rolling element 114. In some embodiments, the bearing assembly 1600 may comprise at least two ball bearings, as illustrated in FIG. 16. In some embodiments, the shaft 1500 of the plurality of retractable rolling elements 114 may define the shaft axis 1502. In some embodiments, the shaft axis 1502 defined by the shaft 1500 may extend vertically along the shaft 1500 of each of the plurality of retractable rolling elements 114. In some embodiments, the bearing assembly 1600 of each of the plurality of retractable rolling elements 114 may be configured to rotate over the shaft axis 1502. In various examples, the bearing assembly 1600 may not require any external power source to rotate over the shaft axis 1502.

In some embodiments, each of the plurality of retractable rolling elements 114 may comprise the rolling member 1504. In some embodiments, the rolling member 1504 of the plurality of retractable rolling elements 114 may be coupled through the bearing assembly 1600. In some embodiments, the rolling member 1504 of each of the plurality of retractable rolling elements 114 may be constructed with various shapes. The shape may correspond to cylinder shape. In some embodiments, the rolling member 1504 of each of the plurality of retractable rolling elements 114 may be configured to guide the one or more packages 300. In some embodiments, the rolling member 1504 of each of the plurality of retractable rolling elements 114 may be configured to rotate over the shaft axis 1502 along with the bearing assembly 1600. The rolling member 1504 may be configured to rotate over the shaft axis 1502 upon receiving force due to movement of the one or more packages 300 over the roller conveyor 102.

In some embodiments, each of the plurality of retractable rolling elements 114 may be configured to move between the deployed position and the retracted position. Further, when each of the plurality of retractable rolling elements 114 is positioned at the deployed position, then the plurality of retractable rolling elements 114 may be configured to guide the one or more packages 300 along the skew roller conveyor sorter 102. Further, when each of the plurality of retractable rolling elements 114 is positioned at the retracted position, then the plurality of retractable rolling elements 114 may be configured to divert the one or more packages 300 over the another roller conveyor 112.

In some embodiments, each of the plurality of retractable rolling elements 114 may comprise a pin 1508. In some embodiments, the pin 1508 of each of the plurality of retractable rolling elements 114 may be coupled to the shaft 1500. In some embodiments, the shaft 1500 of each of the plurality of retractable rolling elements 114 may define a pin aperture (not shown). In some embodiments, the pin aperture of the shaft 1500 may be configured to receive the pin 1508. In some embodiments, each of the plurality of retractable rolling elements 114 may comprise a spring 1510. Further, the spring 1510 of each of the plurality of retractable rolling elements 114 may be encased around the shaft 1500. In some embodiments, the spring 1510 that may be encased around the shaft 1500 of the retractable rolling element 114 may be secured between the stationary component 1506 and the pin 1508. In some embodiments, the pin 1508 of the shaft 1500 of each of the plurality of retractable rolling elements 114 may be configured to hold the spring 1510 around the shaft 1500. In some embodiments, the spring 1510 may bias the retractable rolling element 114 to move to the retracted position. For example, the spring 1510 may exert a downward force on the pin 1508 to bias the respective retractable rolling element 114 to move downward to the retracted position.

In an example, when the one or more packages 300 are diverted towards the alternative exit path over the another roller conveyor 112, then the at least one processor may retract the plurality of retractable rolling elements 114 according to size of the one or more packages 300. As illustrated in FIGS. 17-18, the bearing assembly 1600 may comprise a needle bearing 1800. In some embodiments, each of the plurality of retractable rolling elements 114 comprise the shaft 1500. Further, the shaft 1500 of each of the plurality of retractable rolling elements 114 may define the shaft axis 1502. Further, the shaft axis 1502 of the shaft 1500 may extend vertically along each of the plurality of retractable rolling elements 114. Further, the bearing assembly 1600 of each of the plurality of retractable rolling elements 114 may be positioned around the shaft 1500. In some embodiments, the rolling member 1504 of each of the plurality of retractable rolling elements 114 may be coupled to each of the plurality of retractable rolling elements 114 through the bearing assembly 1600.

In some embodiments, the bearing assembly 1600 may comprise the needle bearing 1800. In some embodiments, the needle bearing 1800 (as shown in FIG. 18) may comprise a plurality of long, thin rollers, resembling needles that may hold the rolling member 1504. Further, the needle bearing 1800 may be configured to reduce friction when the rolling member 1504 rotates to guide the one or more packages 300 towards the another roller conveyor 112. Further, the needle bearing 1800 of each of the plurality of retractable rolling elements 114 may be configured to couple the rolling member 1504 coupled to each of the plurality of retractable rolling elements 114. In some embodiments, the needle bearing 1800 may require less space as compared to the ball bearing hence needle bearing 1800 may be used in compact design of the plurality of retractable rolling elements 114. Similar to FIGS. 15-16, in FIGS. 17-18, the spring 1510 may be encased around the shaft 1500. The spring 1510 may be held in place by the pin 1508. In an example, when the plurality of retractable rolling elements 114 moves in the deployed position, then the spring 1510 may compress and a tension is created within the spring. Further, when the plurality of retractable rolling elements 114 moves in the retracted position, then the spring 1510 may release the tension that biases the plurality of retractable rolling elements 114 to move to the retracted position.

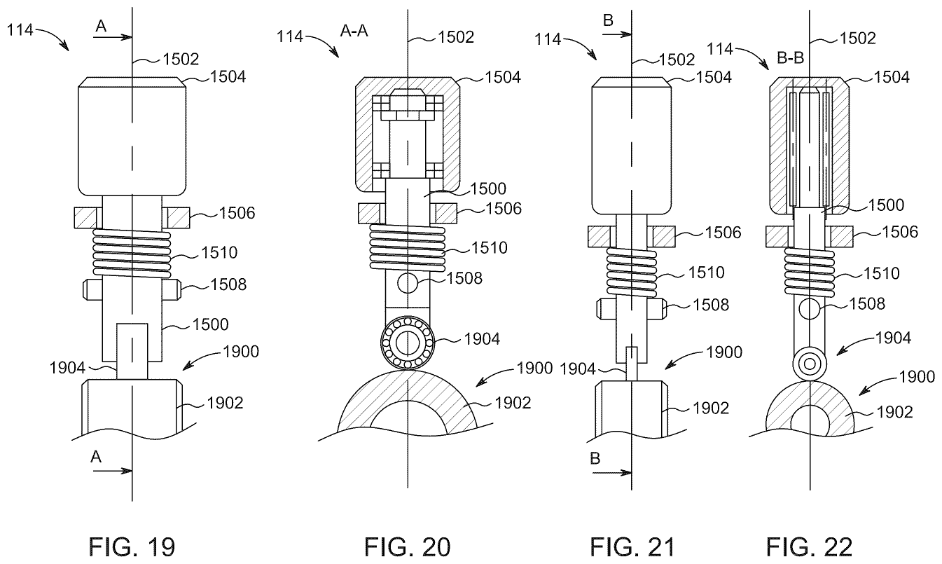

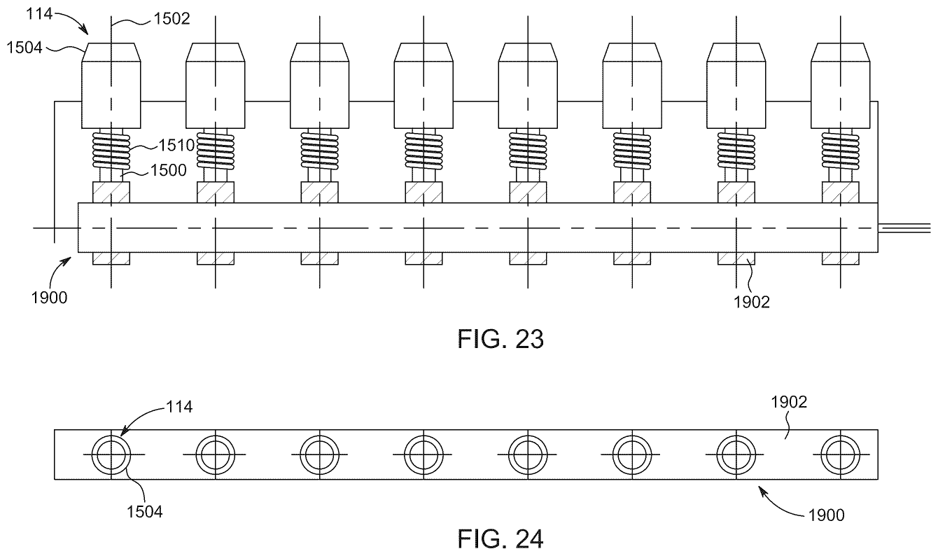

FIG. 19 illustrates a front view of a retractable rolling element 114, according to an example embodiment. FIG. 20 illustrates a sectional view of the retractable rolling element 114 of FIG. 19, according to an example embodiment. FIG. 21 illustrates a front view of a retractable rolling element 114, according to an example embodiment. FIG. 22 illustrates a sectional view of the retractable rolling element 114 of FIG. 21, according to an example embodiment. FIG. 23 illustrates a front view of a live side guide assembly 100 having a plurality of retractable rolling elements 114, according to an example embodiment. FIG. 24 illustrates a top view of the live side guide assembly 100 of FIG. 23, according to an example embodiment. In some embodiments, each of the plurality of retractable rolling elements 114 may be coupled with the actuator 1900. In some embodiments, the actuator 1900 may be configured to move each of the plurality of retractable rolling elements 114 from the retracted position to the deployed position. In some embodiments, the actuator 1900 comprises a motorized driven roller (MDR) (not shown) or a servomotor (not shown) with the one or more cams 1902. In some embodiments, the shaft 1500 of each of the plurality of retractable rolling elements 114 may be coupled with the one or more cams 1902. Further, the MDR may define a rotating axis. Further, the rotating axis of the MDR may extend perpendicularly from the shaft axis 1502 of the shaft 1500 of each of the plurality of retractable rolling elements 114. Further, the MDR may be coupled with a power source (not shown). In some embodiments, the MDR may be coupled with the one or more cams 1902. Further, the MDR may be configured to provide rotations to the one or more cams 1902 along the rotating axis.

In some embodiments, the one or more cams 1902 may be coupled with the shaft 1500 of each of the plurality of retractable rolling elements 114 through a ball bearing 1904. In some embodiments, the ball bearing 1904 may be configured to rotate in alternate direction to the one or more cams 1902. In some embodiments, the one or more cams 1902 may define an irregular shape. Further, during rotations of the one or more cams 1902 along the rotating axis, the irregular shape of the one or more cams 1902 may facilitate the shaft 1500 of each of the plurality of retractable rolling elements 114 to move linearly over the vertical axis extending from each of the plurality of retractable rolling elements 114. Further, when the shaft 1500 of each of the plurality of retractable rolling elements 114 moves linearly over the vertical axis, then each of the plurality of retractable rolling elements 114 may move from the retracted position to the deployed position and vice-versa. In an instance, when the user generates instructions over the display unit to transfer the one or more packages 300 along the skew roller conveyor sorter 102, then the at least one processor may generate a signal to actuate the MDR to rotate along the rotating axis. Further, due to the rotations of the MDR the plurality of retractable rolling elements 114 may be configured to move from the retracted position to the deployed position. In another instance, when the user generates instructions over the display unit to divert the one or more packages 300 towards the another roller conveyor 112 (e.g., take the alternative exit path), then the at least one processor may generate another signal to actuate the MDR to rotate along the rotating axis. Further, due to the rotations of the MDR the plurality of retractable rolling elements 114 may be configured to move from the deployed position to the retracted position.

In another embodiment, when the one or more cams 1902 may be coupled with the servomotor (not shown). The servomotor may be configured to rotate the one or more cams 1902 over the rotating axis. Further, the one or more cams 1902 may be coupled with the shaft 1500 of each of the plurality of retractable rolling elements 114, through the ball bearing 1904. Further, the ball bearing 1904 may be configured to transfer a rotational motion of the one or more cams 1902 to a linear motion of the shaft 1500 of each of the plurality of retractable rolling elements 114. Further, when the shaft 1500 of each of the plurality of retractable rolling elements 114 moves in the linear motion, then each of the plurality of retractable rolling elements 114 may move from the retracted position to the deployed position and vice-versa.

In some embodiments, the actuator 1900 may comprise a motorized linear actuator. In some embodiments, the motorized linear actuator may be coupled to the shaft 1500 of each of the plurality of retractable rolling elements 114. In some embodiments, the motorized linear actuator may be configured to convert rotational motion from an electric motor into linear motion. For example, the motorized linear actuator uses a screw mechanism, such as a lead screw or ball screw, where the motor rotates the screw, causing a nut or platform attached to the screw to move linearly. In one instance, the motorized linear actuator may be collectively coupled to the shaft 1500 of each of the plurality of retractable rolling elements 114. In another instance, the motorized linear actuator may be separately coupled to the shaft 1500 of each of the plurality of retractable rolling elements 114. In some embodiments, the motorized linear actuator may be coupled with a power source (not shown). In some embodiments, the motorized linear actuator may be configured to provide a linear motion to the shaft 1500 of each of the plurality of retractable rolling elements 114, upon receiving a power supply from the power source. Further, when the shaft 1500 of each of the plurality of retractable rolling elements 114 moves in the linear motion, then each of the plurality of retractable rolling elements 114 may move from the retracted position to the deployed position and vice-versa.

As illustrated in FIGS. 19-22, each of the plurality of retractable rolling elements 114 comprise the bearing assembly 1600. Further, the bearing assembly 1600 may be positioned around the shaft 1500 to hold the rolling member 1504. Each of the rolling members 1504 may be coupled to each of the plurality of retractable rolling elements 114. In an example, the bearing assembly 1600 may comprise the ball bearing and/or the needle bearing 1800. In some embodiments, the bearing assembly 1600 of each of the plurality of retractable rolling elements 114 may be configured to rotate over the shaft axis 1502. In various examples, the bearing assembly 1600 may not require any external power source to rotate over the shaft axis 1502. In some embodiments, the rolling member 1504 of each of the plurality of retractable rolling elements 114 may be configured to rotate over the shaft axis 1502 along with the bearing assembly 1600. The rolling member 1504 may be configured to rotate over the shaft axis 1502 upon receiving force due to movement of the one or more packages 300 along the skew roller conveyor sorter 102.

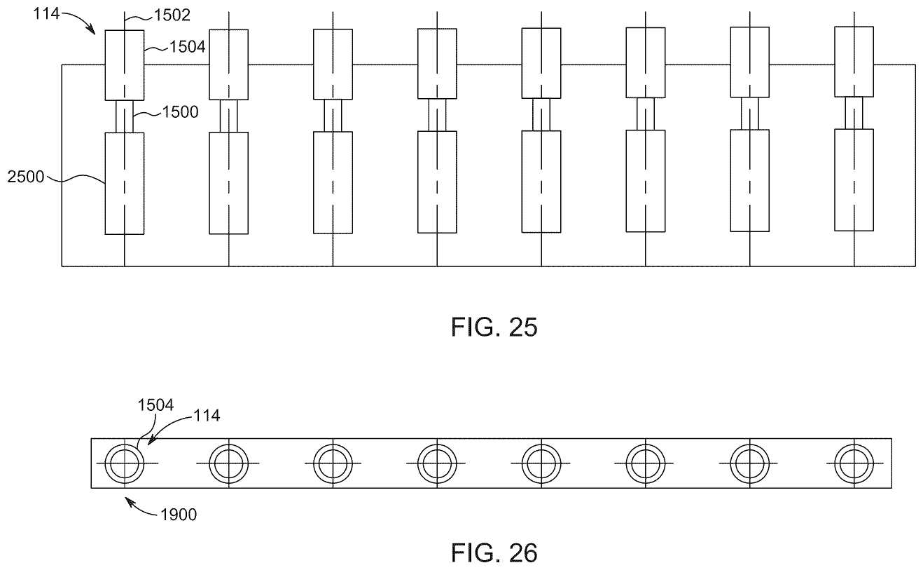

FIG. 25 illustrates a front view of a live side guide assembly having a plurality of retractable rolling elements 114, according to an example embodiment. FIG. 26 illustrates a top view the live side guide assembly 100 of FIG. 25, according to an example embodiment.

In some embodiments, the plurality of retractable rolling elements may be paired with an actuator 1900. The actuator 1900 may comprise the pneumatic linear actuator 2500. In some embodiments, the pneumatic linear actuator 2500 may be coupled to the shaft 1500 of each of the plurality of retractable rolling elements 114. In some embodiments, the pneumatic linear actuator 2500 may be configured to operate by using compressed air to generate linear motion. Further, the pneumatic linear actuator 2500 may comprise a pneumatic cylinder having compressed air. Further, a piston inside the pneumatic cylinder pushes the air inside the cylinder, which in turn moves the connected load (i.e., the shaft 1500). In one instance, the pneumatic linear actuator 2500 may be collectively coupled to the shaft 1500 of each of the plurality of retractable rolling elements 114. In another instance, the pneumatic linear actuator 2500 may be separately coupled to the shaft 1500 of each of the plurality of retractable rolling elements 114, as illustrated in FIG. 25. In some embodiments, the pneumatic linear actuator 2500 may be configured to provide a linear motion to the shaft 1500 of each of the plurality of retractable rolling elements 114. Further, when the shaft 1500 of each of the plurality of retractable rolling elements 114 moves in the linear motion, then each of the plurality of retractable rolling elements 114 may move from the retracted position to the deployed position and vice-versa. In some embodiments, each of the plurality of retractable rolling elements 114 comprise the bearing assembly 1600. Further, the bearing assembly 1600 may be positioned around the shaft 1500 to hold the rolling member 1504. In some embodiments, the bearing assembly 1600 of each of the plurality of retractable rolling elements 114 may be configured to rotate over the shaft axis 1502. In some embodiments, the rolling member 1504 of each of the plurality of retractable rolling elements 114 may be configured to rotate over the shaft axis 1502 along with the bearing assembly 1600. The rolling member 1504 may be configured to rotate over the shaft axis 1502 upon receiving force due to movement of the one or more packages 300 along the skew roller conveyor sorter 102.

In some embodiments, a method for operating the live side guide assembly 100 for the skew roller conveyor sorter 102 is disclosed. Further, the method comprises one or more operations. At an operation, the plurality of retractable rolling elements 114 may be positioned along at least one side of the skew roller conveyor sorter 102. Further, the each of the plurality of retractable rolling elements 114 may be positioned on the live side guide assembly 100 through the plurality of orifices. The plurality of orifices may be defined by the stationary component 1506 (shown in FIG. 15) that may be immovable part of the live side guide assembly 100. At another operation, the bearing assembly 1600 of each of the plurality of retractable rolling elements 114 may be coupled around the shaft 1500 defining the shaft axis 1502. In some embodiments, the bearing assembly 1600 may be a ball bearing or the needle bearing 1800. At another operation, the rolling member 1504 of each of the plurality of retractable rolling elements 114 may be positioned around the bearing assembly 1600. Further, the rolling member 1504 may be configured to rotate on the shaft axis 1502. At another operation, each of the plurality of retractable rolling elements 114 may be positioned such that the shaft axis 1504 may extend vertically. At another operation, the plurality of retractable rolling elements 114 may be configured to move between the deployed position for guiding the one or more packages 300 and the retracted position for diverting the one or more packages 300.

The proposed solution may offer an efficient and reliable mechanism for diverting the one or more packages 300 in the skew roller conveyor sorter 102 through its innovative design. The solution may incorporate a live side guide assembly 100, which may push the one or more packages 300 along the diversion path. The live side guide assembly 100 may consist of the plurality of retractable rotating elements 114, which may selectively retract based on the dimensions of the one or more packages 300, facilitating seamless diversion. This configuration may allow for precise control of the one or more package flow and diversion, ensuring smooth and consistent operation while accommodating varying package sizes without the need for additional adjustments.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A live side guide assembly for a skew roller conveyor, the live side guide assembly comprising:
a plurality of retractable rolling elements configured to be positioned along at least one side of the skew roller conveyor, wherein each of the plurality of retractable rolling elements comprise:
a shaft defining a shaft axis;
a bearing assembly positioned around the shaft; and
a rolling member that is positioned around the bearing assembly and is configured to rotate on the shaft axis,
wherein:
each of the plurality of retractable rolling elements are configured to be positioned such that the shaft axis extends vertically, and
each of the plurality of retractable rolling elements are configured to move between a deployed position for guiding one or more packages and a retracted position for diverting the one or more packages.

2. The live side guide assembly of claim 1, wherein the live side guide assembly comprises a stationary component that defines a plurality of orifices, wherein the shaft of each of the plurality of retractable rolling elements extend through a respective orifice of the plurality of orifices, and wherein each of the plurality of retractable rolling elements comprise:
a pin coupled to the shaft; and
a spring encased around the shaft and secured between the stationary component and the pin, wherein the spring is configured to bias each of the plurality of retractable rolling elements to move to the retracted position.

3. The live side guide assembly of claim 1, wherein the bearing assembly comprises a ball bearing or a needle bearing.

4. The live side guide assembly of claim 1, wherein the plurality of retractable rolling elements are segmented into a plurality of zones.

5. The live side guide assembly of claim 4, wherein the plurality of retractable rolling elements of each of the plurality of zones are configured to move independently between the deployed position and the retracted position based at least on a size of the one or more packages.

6. The live side guide assembly of claim 1, wherein each of the plurality of retractable rolling elements are coupled with an actuator that is configured to move the plurality of retractable rolling elements from the retracted position to the deployed position.

7. The live side guide assembly of claim 6, wherein the actuator comprises a motorized driven roller (MDR) or a servomotor with one or more cams.

8. The live side guide assembly of claim 6, wherein the actuator comprises a motorized linear actuator.

9. The live side guide assembly of claim 6, wherein the actuator comprises a pneumatic linear actuator.

10. The live side guide assembly of claim 1, wherein the skew roller conveyor is configured to push the one or more packages towards the plurality of retractable rolling elements to guide the one or more packages along the skew roller conveyor or divert the one or more packages to another roller conveyor.

11. The live side guide assembly of claim 10, wherein the skew roller conveyor defines a rotating speed S1 and each of the plurality of retractable rolling elements defines a moving speed S2, wherein S2 is higher than S1.

12. A method comprising:
positioning a plurality of retractable rolling elements along at least one side of a skew roller conveyor;
coupling a bearing assembly of each of the plurality of retractable rolling elements, around a shaft defining a shaft axis;
positioning a rolling member of each of the plurality of retractable rolling elements, around the around the bearing assembly, wherein the rolling member rotates on the shaft axis;
positioning each of the plurality of retractable rolling elements such that the shaft axis extends vertically; and
moving the plurality of retractable rolling elements between a deployed position for guiding one or more packages and a retracted position for diverting the one or more packages.

13. The method of claim 12, wherein the skew roller conveyor comprises a stationary component that defines a plurality of orifices, and further comprising extending the shaft of each of the plurality of retractable rolling elements through a respective orifice of the plurality of orifices and wherein each of the plurality of retractable rolling elements comprise:
a pin coupled to the shaft; and
a spring encased around the shaft and secured between the stationary component and the pin, and further biasing via the spring each of the plurality of retractable rolling elements to move to the retracted position.

14. The method of claim 12, wherein the bearing assembly comprises a ball bearing or a needle bearing.

15. The method of claim 12, further comprising, segmenting the plurality of retractable rolling elements into a plurality of zones, and further comprising moving the plurality of retractable rolling elements of each of the plurality of zones independently between the deployed position and the retracted position based at least on a size of the one or more packages.

16. The method of claim 12, further comprising coupling an actuator with each of the plurality of retractable rolling elements to move the retractable rolling element from the retracted position to the deployed position.

17. The method of claim 16, wherein the actuator comprises a motorized driven roller (MDR) or a servomotor with one or more cams.

18. The method of claim 16, wherein the actuator comprises a motorized linear actuator.

19. The method of claim 16, wherein the actuator comprises a pneumatic linear actuator.

20. The method of claim 12, wherein the method further comprising pushing, via the skew roller conveyor, the one or more packages towards the plurality of retractable rolling elements to guide the one or more packages along the skew roller conveyor or divert the one or more packages to another roller conveyor, wherein the skew roller conveyor defines a rotating speed S1 and each of the plurality of retractable rolling elements defines a moving speed S2, wherein S2 is higher than S1.
